(19) United States
(12) Patent Application Publication
(10) Pub. No.: US 2009/0035541 A1
(43) Pub. Date: Feb. 5, 2009

(54) Metal laminate, method for manufacturing same and use thereof

(75) Inventors: Shuichi Yokozawa, Chiba (JP); Koji Hirota, Kanagawa (JP); Shuji Tahara, Chiba (JP)

Correspondence Address: BUCHANAN, INGERSOLL & ROONEY PC, POST OFFICE BOX 1404, ALEXANDRIA, VA, 22313-1404, US

(73) Assignee: Mitsui Chemicals, Inc., Minato-ku (JP)

(21) Appl. No.: 11/918,730

(22) PCT Filed: Apr. 14, 2006
(86) PCT No.: PCT/JP2006/307959

§ 371 Date: Oct. 18, 2007

(30) Foreign Application Priority Data
Apr. 18, 2005 (JP) 2005-119315

(51) Int. Cl. B32B 3/00; H01B 13/10

(52) U.S. Cl. 428/209; 156/52

(57) ABSTRACT

The present invention relates to a polyimide metal laminate which is a metal laminate comprising a stainless steel layer/a conductor layer/a polyimide resin layer/a metal layer, wherein the conductor layer is interposed between the stainless steel layer and the polyimide resin layer as a ground, and having a strong adhesion between the conductor layer and the polyimide resin layer, thus being able to be processed and used as a hard disk suspension. Specifically, the metal laminate of the present invention is characterized in that a surface of the conductor layer in contact with the polyimide resin layer is not smooth (preferably its 10-point average surface roughness is 0.5 μm or more).

### TECHNICAL FIELD

The present invention relates to a polyimide metal laminate, more particularly, to a polyimide metal laminate used for a wireless suspension and the like in a flexible wiring board and a hard disk drive.

### BACKGROUND ART

In recent years, as miniaturization and sophistication of a hard disk drive is rapidly advanced, a light weight hard disk suspension effective for miniaturization of the hard disk drive is used. Particularly, a wireless suspension having a copper wiring that is formed as a circuit on a suspension is used rather than a suspension having a transmission line connecting between a magnetic head and a preamplifier in wire. As a material for the wireless suspension, a polyimide metal laminate comprising a copper alloy layer/a polyimide resin layer/a stainless steel layer (SUS 304, for instance) has been used.

Further, as the recording capacity of a hard disk drive is dramatically increased, processing of huge data in a short time is required during reading and writing on the magnetic head, thus higher frequency than before for writing and reading is requested. However, in the conventional composition of a copper-based alloy layer/a polyimide resin layer/a stainless steel layer, when the frequency for writing and reading is remarkably increased, there is a possibility that transmission loss in a writing and reading line or a crosstalk between wiring lines occurs. Accordingly, investigations have been made on the base material in which a conductor layer is interposed as a ground between a polyimide resin layer and a stainless steel layer.

As mentioned above, in an investigation on a wireless suspension for high frequency having a conductor layer interposed between a stainless steel layer and a polyimide resin layer, an attempt for improving electrical properties owing to a reduction in the transmission loss in a transmission line and achieving a flat impedance of a transmission line has been made by providing a conductor layer between the stainless steel layer and the polyimide resin layer (see Patent Document 1 for example).

Further, as a countermeasure for the electromagnetic interference, an investigation has been made to minimize a crosstalk through reducing the interaction between signals of reading and writing by providing a conductor layer between the stainless steel layer and the polyimide layer (see Patent Document 2 for example).

In the above two references, it is shown from simulations performed on electrical properties in a hard disk suspension wiring that a certain effect can be obtained by interposing a conductor layer as a ground. However, the evaluation has not been made by actually preparing a base material from a metal laminate comprising a stainless steel layer/a conductor layer/a polyimide resin layer/a metal (copper) layer, thus practicality of the base material has not been investigated.

### [Patent Document 1] Japanese Patent Laid-Open Publication No. 2005-11387

### [Patent Document 2] Japanese Patent Laid-Open Publication No. 2004-55126

### DISCLOSURE OF THE INVENTION

### Problems to be Solved by the Invention

The present inventors found that, by investigating adhesion of each layer of a metal laminate comprising a stainless steel layer/a conductor layer/a polyimide resin layer/a metal (copper) layer, there were some cases where sufficient adhesion strength was not obtained and this was due to poor adhesion between the polyimide resin layer and the conductor layer. Accordingly, an object of the present invention is to provide a polyimide metal laminate durable for processing and use as a hard disk suspension, having a conductor layer interposed between a stainless steel layer and a polyimide layer as a ground and also having a high adhesion strength between the conductor layer and the polyimide resin layer in order to solve problems of electrical properties such as the transmission loss and the electromagnetic interference.

### Means for Solving the Problems

The present inventors, as a result of extensive investigation, found that, in a polyimide metal laminate interposed by a conductor layer that can improve electrical properties such as the transmission loss and the electromagnetic interference, adhesion between the conductor layer and the polyimide resin layer was improved by roughing a surface of the conductor layer in contact with the polyimide resin layer. Based on this finding, the present invention was completed by providing a roughness to the surface of the conductor layer in contact with the polyimide resin layer by a surface treatment, preferably by an acid treatment.

Namely, the first invention relates to a metal laminate which is specified as follows.

[1] A metal laminate comprising:

a stainless steel layer;

a conductor layer disposed on at least one surface of the stainless steel layer;

a polyimide resin layer disposed on a surface of the conductor layer; and

a metal layer disposed on a surface of the polyimide resin layer,

wherein a surface of the conductor layer in contact with the polyimide resin layer is not smooth.
[2] The metal laminate according to the above [1], wherein a 10-point average surface roughness Rz of the conductor layer in contact with the polyimide resin layer is 0.5 μm or more and not more than the value obtained by subtracting 0.3 μm from the thickness of the conductor layer.
[3] The metal laminate according to the above [1], wherein a surface of the conductor layer in contact with the polyimide resin layer is subjected to an acid treatment.
[4] The metal laminate according to the above [3], wherein the acid treatment is performed by using a solution containing formic acid, or a solution containing sulfuric acid and a peroxide.
[5] The metal laminate according to the above [1], wherein the thickness of the conductor layer is in the range of 0.5 μm to 20 μm.
[6] The metal laminate according to the above [1], wherein the conductor layer is composed of copper or copper-based alloy.
[7] The metal laminate according to the above [1], wherein the polyimide resin layer is composed of a non-thermoplastic polyimide layer and thermoplastic polyimide layers disposed on each of both surfaces of the non-thermoplastic polyimide layer.

The second invention relates to a method for manufacturing a metal laminate, which is specified as follows.

[8] A method for manufacturing a metal laminate composed of a stainless steel layer, a conductor layer disposed on at least one surface of the stainless steel layer, a polyimide resin layer disposed on a surface of the conductor layer, and a metal layer disposed on a surface of the polyimide resin layer, comprising a step of:

bonding the conductor layer of a stainless steel layer/conductor layer laminate composed of the stainless steel layer and the conductor layer to the polyimide resin layer of a polyimide metal laminate composed of the metal layer and the polyimide resin layer by thermal compression,

wherein the stainless steel layer/conductor layer laminate is a laminate obtained by subjecting a surface of a conductor layer formed on a stainless steel foil by a plating method to an acid treatment.
[9] A method for manufacturing a metal laminate composed of a stainless steel layer, a conductor layer disposed on at least one surface of the stainless steel layer, a polyimide resin layer disposed on a surface of the conductor layer, and a metal layer disposed on a surface of the polyimide resin layer, comprising steps of:

forming the polyimide resin layer on the conductor layer of a stainless steel layer/conductor layer laminate composed of the stainless steel layer and the conductor layer; and bonding a metal foil on the formed polyimide resin layer by thermal compression,

wherein the stainless steel layer/conductor layer laminate is a laminate obtained by subjecting a surface of the conductor layer formed on a stainless steel foil by a plating method to an acid treatment.

The third invention relates to a suspension for a hard disk, which is specified as follows.

[10] A suspension for a hard disk that contains a processed article of the metal laminate according to any of the above [1] to [7].

### EFFECTS OF THE INVENTION

According to the present invention, a metal laminate composed of a stainless steel layer/a conductor layer/a polyimide resin layer/a metal layer and having strong adhesion between the conductor layer and the polyimide resin layer can be obtained by roughing a surface of the conductor layer in contact with the polyimide resin layer. Because the metal laminate is interposed by a conductor layer capable of functioning as a ground layer, it can be suitably used as a suspension material for a hard disk drive having excellent electrical properties.

In addition, the metal laminate of the present invention can be manufactured by a roll process, thus it can provide an inexpensive suspension having a circuit which can be made in high density.

### BEST MODE OF CARRYING OUT THE INVENTION

In the following, the metal laminate of the present invention, a method for manufacturing it, and use thereof are explained in detail.

### 1. The Metal Laminate of the Present Invention

The metal laminate of the present invention is characterized in that it comprises a stainless steel layer, a conductor layer disposed on a surface of the stainless steel layer, a polyimide resin layer disposed on a surface of the conductor layer, and a metal layer disposed on a surface of the polyimide resin layer, wherein the surface of the conductor layer in contact with the polyimide resin layer is not smooth.

### (1) A Stainless Steel Layer

Although a stainless steel layer, which is a constitutional element of the present invention, is not particularly restricted so long as it is a layer comprising stainless steel, it is preferably SUS 304 stainless steel, and more preferably SUS 304 stainless steel that is tension-annealed at a temperature of 300° C. or higher in view of spring properties and dimensional stability required for a suspension material taking into consideration that the metal laminate is used as a suspension. The thickness of the stainless steel layer is preferably in the range of 10 μm to 70 μm and more preferably in the range of 15 μm to 30 μm.

### (2) A Conductor Layer

A conductor layer, which is a constitutional element of the metal laminate of the present invention, is disposed on at least one surface of a stainless steel layer, preferably on either one of its surfaces. The phrase “disposed on a surface” means that the stainless steel layer and the conductor layer are disposed contiguously or they are disposed through an intermediate layer.

When the metal laminate of the present invention is used as a base material for a circuit board (a suspension for a hard disk drive, for example), the conductor layer may have a function as a ground layer. Owing to the ground layer, the electromagnetic interference among transmission lines and the transmission loss in a transmission line can be reduced. In recent years, in a suspension for a hard disk, high densification of a transmission line and use of higher frequency for reading and writing signals owing to improvement in the recording density are going on, thus the above mentioned electromagnetic interference and transmission loss are becoming apparent problems. A metal laminate containing a conductor layer as a ground layer may be useful to address such problems.

As a material for the metal laminate, which is a constitutional element of the present invention, a metal having a large electric conductivity is preferred. Preferable examples include gold, silver, copper, nickel, stainless steel, aluminum, and the like. Taking into consideration of the electric conductivity of the conductor layer and productivity of the metal laminate, copper or copper-based alloy are more preferred.

The thickness of the conductor layer is not particularly restricted so long as it can serve as a ground, though it is preferably in the range of 0.5 μm to 20.0 μm, and more preferably in the range of 0.8 μm to 5.0 μm in view of electrical and mechanical properties. Since a surface of the conductor layer is not smooth, there may be a case where an underlying layer (a stainless steel layer) is exposed if the thickness of the conductor layer is too small. Further, taking into consideration of its use as a suspension, the thickness of the conductor layer of 20 μm or less is preferred in view of stiffness.

The metal laminate of the present invention is characterized in that a surface of the conductor layer in contact with the polyimide resin layer is not smooth. The term “not smooth” used in the present invention means that a 10-point average surface roughness Rz is preferably 0.5 μm or more. Here, the 10-point average surface roughness Rz is a measured distance value between the third highest peak line and the third deepest valley line along a standard length extracted from a cross-section curve.

Inherently, a conductor layer formed on a surface of a stainless steel layer having a 10-point average surface roughness of 1.0 μm or less by a plating method is in a state of being a very smooth surface. Generally, when a polyimide resin layer is laminated on this smooth surface, there occurs a problem of poor adhesion between the resin and the conductor layer at their interface.

Especially, in a conductor layer formed by electroplating (a copper layer, for instance), there is a case where its adhesion with a resin layer laminated thereon is very poor. The present inventors found that this was because the polyimide resin layer laminated on a conductor layer is easily peeled off due to a brittle fracture inside the conductor layer, since an intermetallic bond at the outermost surface layer of the conductor layer is so weak that it becomes a very brittle layer.

From these findings, the present inventors found that, in order to secure sufficient adhesion between the conductor layer and the polyimide resin layer, it is preferred to make a surface of the conductor layer in a state of being not smooth but a state of being uneven, and in addition to remove a brittle layer at the outermost surface layer of the conductor layer.

A polyimide layer can adhere firmly to a conductor layer having a rough surface. In order to secure firmer adhesion, it is preferred that the 10-point average roughness Rz at a surface of the conductor layer is 0.5 μm or more. On the other hand, when the roughness Rz is extremely greater than 0.5 μm, although there is no problem in the adhesion with the polyimide resin layer, a care is necessary not to completely perform etching of the conductor layer so as not to expose an underlying layer since in many cases the conductor layer is so thin as it is formed by a plating method. For example, when the thickness of the conductor layer is 2.0 μm, in order to prevent complete etching of the conductor layer, it is necessary to secure a margin of about 0.3 μm by making the 10-point average roughness Rz 1.7 μm or less. Namely, it is preferred that the 10-point average roughness of a surface of the conductor layer is 0.5 μm or more and not more than the value obtained by subtracting 0.3 μm from the thickness of the conductor layer.

A means for making a surface of the conductor layer not smooth, namely a means for roughing treatment will be mentioned later.

As mentioned above, it is preferred that not only a surface of the conductor layer is rough but also a brittle part at its outermost layer is appropriately removed. Removal of this brittle part is performed by appropriately etching the surface of the conductor layer, and this etching treatment will also be described later.

As mentioned above, an intermediate layer may be interposed between the stainless steel layer and the conductor layer of the metal laminate of the present invention. Particularly, when a metal for a conductor layer is plated directly on a stainless steel layer (a plating method will be mentioned later), there is a possibility that adhesion at the interface of the stainless steel layer and the conductor layer is not developed. Accordingly, a layer (an adhesion layer) that is capable of bonding the stainless steel layer to the conductor layer may be provided between them. As a preferred example of the adhesion layer, a nickel layer such as a strike nickel with a thickness of 0.1 μm or less may be included. The thickness of such a plated underlying layer comprising nickel or nickel-based alloy suffices when it is 0.1 μm or less.

### (3) A Polyimide Resin Layer

A polyimide resin layer that is a constitutional element of the metal laminate of the present invention is preferably disposed on a surface of the conductor layer in direct contact. The polyimide resin layer can adhere firmly to a non-smooth surface of the conductor layer.

The polyimide resin layer may function as an electrically insulating layer between the conductor layer and the metal layer. The polyimide resin layer is formed from resin composition comprising polyimide resin, and its thickness suffices when it is in the range of about 7 μm to 250 μm.

The polyimide resin layer may have a multi-layered structure, preferably a three-layered structure. More preferably, the polyimide resin layer has a structure comprising a non-thermoplastic polyimide layer and thermoplastic polyimide layers disposed on both surfaces of the non-thermoplastic polyimide layer (a thermoplastic polyimide layer/a non-thermoplastic polyimide layer/a thermoplastic polyimide layer). By making the polyimide resin layer as such a three-layered structure, the surfaces contacting the conductor layer and the metal layer are to be the thermoplastic polyimide layers and the other layer (the inner layer) is to be the non-thermoplastic polyimide layer.

From a viewpoint that the heat resistance is often one of the prerequisite items under the conditions where the metal laminate of the present invention is used, resin composition constituting a non-thermoplastic polyimide layer that may be included in the polyimide resin layer preferably contains non-thermoplastic polyimide, and may contain filler.

The thickness of the non-thermoplastic polyimide layer is not particularly restricted, though the range of 6 μm to 150 μm is preferred, the range of 12.5 μm to 100 μm is more preferred, and the range of 12.5 μm to 75 μm is further preferred.

The non-thermoplastic polyimide layer may be a commercially available film, which specifically includes for example “Kapton (registered trademark) Super V”, “Kapton (registered trademark) V”, “Kapton (registered trademark) E”, “Kapton (registered trademark) EN”, and “Kapton (registered trademark) H” (all these are produced by Du Pont-Toray Co., Ltd.), “UPILEX (registered trademark) S” and “UPILEX (registered trademark) SGA” (these are produced by Ube Industries, Ltd.), “Apical (registered trademark) AH”, “Apical (registered trademark) NPI”, and “Apical HP” (all these are produced by Kaneka Corp.), and the like. They are easily available in the market and can be suitably used for the present invention.

Further, the non-thermoplastic polyimide contained in the non-thermoplastic polyimide layer may be polyimide that is formed by direct imidation of carboxylic dianhydride with diamine.

The first category of examples of the carboxylic dianhydrides for the raw material of the non-thermoplastic polyimide is pyromellitic dianhydride derivatives, which include pyromellitic dianhydride, 3-fluoropyomellitic dianhydride, 3,6-difluoropyromellitic dianhydride, 3,6-bis(trifluoromethyl)pyromellitic dianhydride and the like.

The second category of examples of the carboxylic dianhydrides for the raw material of the non-thermoplastic polyimide is diphthalic dianhydride derivatives, which include methylene-4,4′-diphthalic dianhydride, 1,1-ethylidene-4,4′-diphthalic dianhydride, 2,2-propylidene-4,4′-diphthalic dianhydride, 1,2-ethylene-4,4′-diphthalic dianhydride, 1,3-trimethylene-4,4′-diphthalic dianhydride, 1,4-tetramethylene-4,4′-diphthalic dianhydride, 1,5-pentamethylene-4,4′-diphthalic dianhydride, difluoromethylene-4,4′-diphthalic dianhydride, 1,1,2,2-tetrafluoro-1,2-ethylene-4,4′-diphthalic dianhydride, 1,1,2,2,3,3-hexafluoro-1,3-trimethylene-4,4′-diphthalic dianhydride, 1,1,2,2,3,3,4,4-octafluoro-1,4-tetramethylene-4,4′-diphthalic dianhydride, 1,1,2,2,3,3,4,4,5,5-decafluoro-1,5-pentamethylene-4, 4′-diphthalic dianhydride, oxy-4,4′-diphthalic dianhydride, thio-4,4′-diphthalic dianhydride, sulfonyl-4,4′-diphthalic dianhydride, 1,2,3,4-benzenetetracarboxylic dianhydride, 2,2′,3,3′-benzophenonetetracarboxylic dianhydride, 3,3′,4,40-biphenyltetracarboxylic dianhydride, 3,3″,4,4″-terphenyltetracarboxylic dianhydride, 3,3″″,4,4″″-quaterphenyltetracarboxylic dianhydride, 3,3″,4,4″-quinquephenyltetracarboxylic dianhydride, 2,2′,3,3′-biphenyltetracarboxylic dianhydride, 3,3′-difluoro-4,4′-diphthalic dianhydride, 5,5′-difluoro-4,4′-diphthalic dianhydride, 6,6′-difluoro-4,4′-diphthalic dianhydride, 3,3′,5,5′,6,6′-hexafluoro-4,4′-diphthalic dianhydride, 3,3′-bis(trifluoromethyl)oxy-4,4′-diphthalic dianhydride, 5,5′-bis(trifluoromethyl)oxy-4,4′-diphthalic dianhydride, 6,6′-bis(trifluoromethyl)oxy-4,4′-diphthalic dianhydride, 3,3′,5,5′-tetrakis(trifluoromethyl)oxy-4,4′-diphthalic dianhydride, 3,3′,6,6′-tetrakis(trifluoromethyl)oxy-4,4′-diphthalic dianhydride, 5,5′,6,6′-tetrakis(trifluoromethyl)oxy-4,4′-diphthalic dianhydride, 3,3′,5,5′,6,6′-hexakis(trifluoromethyl)oxy-4,4′-diphthalic dianhydride, 3,3′-bis(fluorosulfonyl)-4,4′-diphthalic dianhydride, 5,5′-bis(fluorosulfonyl)-4,4′-diphthalic dianhydride, 6,6′-bis(fluorosulfonyl)-4,4′-diphthalic dianhydride, 3,3′,5,5′,6,6′-hexakis(fluorosulfonyl)-4,4′-diphthalic dianhydride, 3,3′-bis(trifluoromethyl)sulfonyl-4,4′-diphthalic dianhydride, 5,5′-bis(trifluoromethyl)sulfonyl-4,4′-diphthalic dianhydride, 6,6′-bis(trifluoromethyl)sulfonyl-4,4′-diphthalic dianhydride, 3,3′,5,5′-tetrakis(trifluoromethyl)sulfonyl-4,4′-diphthalic dianhydride, 3,3′,6,6′-tetrakis(trifluoromethyl)sulfonyl-4,4′-diphthalic dianhydride, 5,5′,6,6′-tetrakis(trifluoromethyl)sulfonyl-4,4′-diphthalic dianhydride, 3,3′,5,5′,6,6′-hexakis(trifluoromethyl)sulfonyl-4,4′-diphthalic dianhydride, 3,3′-difluoro-2,2-perfluoropropylidene-4,4′-diphthalic dianhydride, 5,5′-difluoro-2,2-perfluoropropylidene-4,4′-diphthalic dianhydride, 6,6′-difluoro-2,2-perfluoropropylidene-4,4′-diphthalic dianhydride, 3,3′,5,5′,6,6′-hexafluoro-2,2-perfluoropropylidene-4, 4′-diphthalic dianhydride, 3,3′-bis(trifluoromethyl)-2,2-perfluoropropylidene-4, 4′-diphthalic dianhydride, 5,5′-bis(trifluoromethyl)-2,2-perfluoropropylidene-4, 4′-diphthalic dianhydride, 6,6′-difluoro-2,2-perfluoropropylidene-4,4′-diphthalic dianhydride, 3,3′,5,5′-tetrakis(trifluoromethyl)-2,2-perfluoropropylidene-4,4′-diphthalic dianhydride, 3,3′,6,6′-tetrakis(trifluoromethyl)-2,2-perfluoropropylidene-4,4′-diphthalic dianhydride, 5,5′,6,6′-tetrakis(trifluoromethyl)-2,2-perfluoropropylidene-4,4′-diphthalic dianhydride, 3,3′,5,5′,6,6′-hexakis(trifluoromethyl)-2,2-perfluoropropylidene-4,4′-diphthalic dianhydride, and the like.

The third category of examples of the carboxylic dianhydride for the raw material of the non-thermoplastic polyimide is biphenyltetracarboxylic dianhydride derivatives, which include 2,2′-difluoro-3,3′,4,4′-biphenyltetracarboxylic dianhydride, 5,5′-difluoro-3,3′,4,4′-biphenyltetracarboxylic dianhydride, 6,6′-difluoro-3,3′,4,4′-biphenyltetracarboxylic dianhydride, 2,2′,5,5′,6,6′-hexafluoro-3,31,4,4′-biphenyltetracarboxylic dianhydride, 2,2′-bis(trifluoromethyl)-3,3′,4,4′-biphenyltetracarboxylic dianhydride, 5,5′-bis(trifluoromethyl)-3,3′,4,4′-biphenyltetracarboxylic dianhydride, 6,6′-bis(trifluoromethyl)-3,3′,4,4′-biphenyltetracarboxylic dianhydride, 2,2′,5,5′-tetrakis(trifluoromethyl)-3,3′,4,4′-biphenyltetracarboxylic dianhydride, 2,2′,6,6′-tetrakis(trifluoromethyl)-3,3′,4,4′-biphenyltetracarboxylic dianhydride, 5,5′,6,6′-tetrakis(trifluoromethyl)-3,3′,4,4′-biphenyltetracarboxylic dianhydride, 2,2′,5,5′,6,6′-hexakis(trifluoromethyl)-3,3′,4,4′-biphenyltetracarboxylic dianhydride, and the like.

The fourth category of examples of carboxylic dianhydrides for a raw material of the non-thermoplastic polyimide is bis(cyclohexane-1,2-dicarboxylic) dianhydride derivatives, which include carbonyl-4,4′-bis(cyclohexane-1,2-dicarboxylic) dianhydride, methylene-4,4′-bis(cyclohexane-1,2-dicarboxylic) dianhydride, 1,2-ethylene-4,4′-bis(cyclohexane-1,2-dicarboxylic) dianhydride, 1,1-ethylidene-4,4′-bis(cyclohexane-1,2-dicarboxylic) dianhydride, 2,2-propylidene-4,4′-bis(cyclohexane-1,2-dicarboxylic) dianhydride, 1,1,1,3,3,3-hexafluoro-2,2-propylidene-4,4′-bis(cyclohexane-1,2-dicarboxylic) dianhydride, oxy-4,4′-bis(cyclohexane-1,2-dicarboxylic) dianhydride, thio-4,4′-bis(cyclohexane-1,2-dicarboxylic) dianhydride, sulfonyl-4,4′-bis(cyclohexane-1,2-dicarboxylic) dianhydride, and the like.

The fifth category of examples of the carboxylic dianhydride for the raw material of the non-thermoplastic polyimide includes 1,3-bis(3,4-dicarboxyphenyl)-1,1,3,3-tetramethyldisiloxane dianhydride, 1,3-bis(3,4-dicarboxyphenyl)benzene dianhydride, 1,4-bis(3,4-dicarboxyphenyl)benzene dianhydride, 1,3-bis(3,4-dicarboxyphenoxy)benzene dianhydride, 1,4-bis(3,4-dicarboxyphenoxy)benzene dianhydride, 1,3-bis[2-(3,4-dicarboxyphenyl)-2-propyl]benzene dianhydride, 1,4-bis[2-(3,4-dicarboxyphenyl)-2-propyl]benzene dianhydride, bis[3-(3,4-dicarboxyphenoxy)phenyl]methane dianhydride, bis[4-(3,4-dicarboxyphenoxy)phenyl]methane dianhydride, 2,2-bis[3-(3,4-dicarboxyphenoxy)phenyl]propane dianhydride, 2,2-bis[4-(3,4-dicarboxyphenoxy)phenyl]propane dianhydride, 2,2-bis[3-(3,4-dicarboxyphenoxy)phenyl]-1,1,1,3,3,3-hexafluoropropane dianhydride, 2,2-bis[4-(3,4-dicarboxyphenoxy)phenyl]propane dianhydride, 2,2-bis(3,4-dicarboxyphenyl)-1,1,1,3,3,3-hexafluoropropane dianhydride, bis(3,4-dicarboxyphenoxy)dimethylsilane dianhydride, 1,3-bis(3,4-dicarboxyphenoxy)-1,1,3,3-tetramethyldisiloxane dianhydride, 2,3,6,7-naphthalenetetracarboxylic dianhydride, 1,2,5,6-naphthalenetetracarboxylic dianhydride, 3,4,9,10-perylenetetracarboxylic dianhydride, 2,3,6,7-anthracenetetracarboxylic dianhydride, 1,2,7,8-phenanthrenetetracarboxylic dianhydride, 1,2,3,4-butanetetracarboxylic dianhydride, 1,2,3,4-cyclobutanetetracarboxylic dianhydride, cyclopentanetetracarboxylic dianhydride, cyclohexane-1,2,3,4-tetracarboxylic dianhydride, cyclohexane-1,2,4,5-tetracarboxylic dianhydride, 3,3′,4,4′-bicyclohexyltetracarboxylic dianhydride, 9-phenyl-9-(trifluoromethyl)xanthene-2,3,6,7-tetracarboxylic dianhydride, 9,9-bis(trifluoromethyl)xanthene-2,3,6,7-tetracarboxylic dianhydride, bicyclo[2.2.2]oct-7-ene-2,3,5,6-tetracarboxylic dianhydride, 9,9-bis[4-(3,4-dicarboxy)phenyl)]fluorene dianhydride, 9,9-bis[4-(2,3-dicarboxy)phenyl)]fluorene dianhydride, and the like.

These acid dianhydrides may be used solely or in a combination of two kinds or more.

On the other hand, diamine useful as the raw material for the non-thermoplastic polyimide may include, for example, methoxydiaminobenzene, 4,4′-oxydianiline, 3,4′-oxydianiline, 3,3′-oxydianiline, dianilinomethane, 3,3′-diaminobenzophenone, bis(p-aminophenoxybenzyl)sulfone, bis(m-aminophenoxybenzyl)sulfone, bis(p-aminophenoxybenzyl)ketone, bis(m-aminophenoxybenzyl)ketone, bis(p-aminophenoxybenzyl)hexafluoropropane, bis(m-aminophenoxybenzyl)hexafluoropropane, bis(m-aminophenoxybenzyl)hexafluoropropane, bis(p-aminophenoxybenzyl)propane, bis(o-aminophenoxybenzyl)propane, bis(m-aminophenoxybenzyl)propane, bis(p-aminophenoxybenzyl)thioether, bis(m-aminophenoxybenzyl)thioether, indanediamine, and the like. These diamines may be used solely or in a combination of two kinds or more.

These non-thermoplastic polyimide resins are generally prepared by mixing the carboxylic dianhydride and the diamine at a predetermined ratio in such solvents as N-methylpyrrolidone (NMP), dimethylformamide (DMF), dimethylacetamide (DMAc), dimethylsulfoxide (DMSO), dimethyl sulfate, sulfolane, butylolactone, cresol, phenol, halogenated phenol, cyclohexane, dioxane, tetrahydrofuran (THF), diglyme, triglyme, and the like, then reacting them at the reaction temperature range of 0° C. to 100° C. to obtain a solution including polyamide acid, a precursor of a polyimide resin, followed by further heating the solution at the temperature range of 200° C. to 500° C.

It is preferred that thermoplastic polyimide is included in resin composition constituting the thermoplastic polyimide layer that can be included in the polyimide resin layer. Here, the thermoplastic polyimide is a polymer having an imide structure in the main chain and a glass transition temperature of 150° C. to 350° C., and its modulus of elasticity decreases drastically in that temperature range.

It is preferred that the thermoplastic polyimide is the one that is obtained by polycondensation of at least one diamine selected from the group consisting of 1,3-bis(3-aminophenoxy)benzene, 4,41-bis(3-aminophenoxy)biphenyl and 3,3′-diaminobenzophenone with at least one tetracarboxylic dianhydride selected from the group consisting of 3,3′,4,4′-benzophenonetetracarboxylic dianhydride, 3,3′,4,4′-diphenylethertetracarboxylic dianhydride, pyromellitic dianhydride and 3,3′,4,4′-biphenyltetracarboxylic dianhydride.

The thickness of a thermoplastic polyimide layer on both surfaces of the conductor layer and the metal layer is preferred to be thin similar to the metal layer, and is preferably in the range of 0.5 μm to 50 μm, more preferably in the range of 1 μm to 10 μm in order to realize miniaturization and weight reduction of an electric equipment that uses the metal laminate.

### (4) A Metal Layer

A metal layer that is a constitutional element of the metal laminate of the present invention is disposed on the polyimide resin layer, preferably on the thermoplastic polyimide layer contained in the polyimide resin layer. Although a metal that constitutes the metal layer is not particularly restricted in its kind, the examples of the metal may include, copper, a copper-based alloy, aluminum, nickel, stainless steel, titanium, iron, and the like. Since the metal layer may be an electronic circuit formed by circuit-patterning, a metal constituting the metal layer is preferably a metal having a high electric conductivity. From this viewpoint, it is preferred that the metal layer is a layer comprising copper.

The thickness of a metal layer is preferably in the range of 1 μm to 50 μm, and more preferably 3 μm to 20 μm.

### 2. A Method for Manufacturing the Metal Laminate of the Present Invention

The metal laminate of the present invention can be manufactured by any arbitrary methods, though the following two methods (method A and method B) may be specifically mentioned as examples.

Method A: a stainless steel layer/conductor layer laminate is prepared, wherein a stainless layer and a conductor layer are laminated and the surface of the conductor layer is not smooth; a polyimide metal laminate is prepared, wherein a metal layer and a polyimide resin layer are laminated; and the conductor layer of the stainless steel layer/conductor layer laminate is bonded to the polyimide resin layer of the polyimide metal laminate by thermal compression.

Method B: a stainless steel layer/conductor layer laminate is prepared, wherein a stainless steel layer and a conductor layer are laminated and the surface of the conductor layer is not smooth; a polyimide resin layer is formed on the conductor layer; and then a metal foil is bonded to the polyimide resin layer by thermal compression.

In any of the above mentioned methods, a stainless steel layer/conductor layer laminate is prepared, wherein a stainless steel layer and a conductor layer are laminated. The stainless steel layer/conductor layer laminate is manufactured, for instance, by laminating the conductor layer on the stainless steel foil. As a method for laminating the conductor layer on the stainless steel foil, a method of sputtering or plating a metal that is a material of the conductor layer may be mentioned. Taking into consideration of adhesion between the conductor layer and the metal layer and easiness of film forming, formation of the conductor layer by a plating method is more preferred. Further, taking into consideration of the productivity, formation of the conductor layer by an electroplating method is preferred. Since the electroplating method is a publicly known technology, a manufacturing method is not particularly restricted, thus for example, the plating may be performed according to a method disclosed in “Multilayer Printed Wiring Step 365, Industrial Study Association”.

Further, the stainless steel foil to be laminated with the conductor layer may be laminated in advance with an adhesion layer that enhances adhesion with the conductor layer. As an example of the adhesion layer, a nickel layer, which can be formed by a strike plating, may be included.

Then, a surface of the conductor layer laminated on the stainless steel foil (preferably laminated by a plating method) is made rough, namely subjected to a surface-roughing treatment. Especially a surface of the conductor layer formed by a plating method is generally very smooth, thus needs to be subjected to the roughing treatment. The examples of the roughing treatment include, an electrochemical surface roughing, a chromate-treatment, a chelate treatment, a surface-roughing treatment by etching, and the like, and, a surface-roughing treatment by etching is preferred taking into consideration of productivity of the treatment and workability after the treatment.

The method for the surface-roughing treatment by etching is not particularly restricted so long as the aimed roughing treatment is performed on the conductor layer. The surface-roughing treatment by etching may be performed, for instance, by immersing the conductor layer into an etching solution, or by spraying or coating an etching solution on the surface of the conductor layer of the laminate.

Further, the outermost surface layer of the conductor layer formed by the electroplating method is often very brittle, especially in the case where the component of the conductor layer is copper, thus, it is preferred to remove such a brittle layer. For removing such a brittle part, a treatment by an acidic etching solution is preferred. The examples of the preferred acidic etching solution includes, an etching solution containing sulfuric acid and a peroxide (hydrogen peroxide, for instance), an etching solution containing formic acid, and the like. Concentrations of sulfuric acid and a peroxide contained in the sulfuric acid/peroxide etching solution may be adjusted to those with which the conductor layer is treated appropriately, and for instance, the concentration of sulfuric acid may be in the range of approximately 10% to 30% by weight (23% by weight for example), and that of hydrogen peroxide may be in the range of approximately 5% to 20% by weight (13% by weight for example). Similarly, the concentration of formic acid contained in the etching solution is appropriately adjusted, and may be 10% by weight or more for example. In addition, other arbitrary components may be contained in the acidic etching solution so long as the conductor layer can be treated appropriately.

The acidic etching solution of this type is commercially supplied by many companies. For example, “Neo Brown NBDII (produced by Ebara Densan, Ltd.)”, “V-Bond B07770V (produced by Mec Co., Ltd.)”, “CPE-900 (produced by Mitsubishi Gas Chemical Co., Ltd.)”, and the like may be easily available as the sulfuric acid/peroxide etching solution; and “CZ-8100 (produced by Mec Co., Ltd.)” and the like as the etching solution containing formic acid.

It is preferred that the conductor layer to be surface-treated is immersed in such acidic etching solution. The conditions for immersion are not particularly restricted, and it is usually performed at the temperature range of 20° C. to 50° C. for 10 to 120 seconds. The conditions are controlled depending on the desired degree of roughness.

The polyimide metal laminate in the above-mentioned method A can be prepared by forming the polyimide resin layer on the metal foil (copper foil for instance) that forms the metal layer. In the case where the polyimide resin layer is made in a three-layered structure comprising a non-thermoplastic resin layer and thermoplastic resin layers disposed on both surfaces of the non-thermoplastic resin layer, a polyamic acid which is a precursor of the thermoplastic polyimide resin is coated on the metal foil then dried to form a laminate, followed in a similar manner by coating and drying respective polyamic acids that are precursors of the non-thermoplastic resin and the thermoplastic resin in turn to form the respective layers. After the three layers are laminated and dried, the layers are subjected to a heat-treatment at 200° C. or higher to make each layer as the respective polyimide layer.

The polyimide resin layer of the obtained polyimide metal laminate is disposed on the conductor layer of the above mentioned stainless steel layer/conductor layer laminate, then they are subjected to thermal compression at about 250° C. for about one hour using a vacuum press equipment to obtain a metal laminate comprising a stainless steel layer/a conductor layer/a polyimide resin layer/a metal layer.

Further, as in method B mentioned above, the stainless steel layer/conductor layer/polyimide resin layer laminate may be prepared by forming a polyimide resin layer on the stainless steel layer/conductor layer laminate. The polyimide resin layer is formed by applying a varnish of polyamic acid which is a precursor of the polyimide, followed by drying and heat treatment at 200° C. or higher. The metal laminate of the present invention can be prepared by bonding a metal foil on the polyimide resin layer of the obtained stainless steel layer/conductor layer/polyimide resin layer laminate by thermal compression.

As in the same manner as method A, a polyimide resin layer may be made in a three-layered structure. In such a case, the polyimide resin layer may be formed by applying and drying the respective precursors of a thermoplastic polyimide layer, a non-thermoplastic polyimide layer, and a thermoplastic polyimide layer on the conductor layer in this order.

In addition, a polyimide resin board having the three-layered structure is prepared by applying a varnish of polyamic acid which is a precursor of thermoplastic resin, on both sides of a polyimide film having non-thermoplastic properties (a commercially available film may be used) followed by drying. The metal laminate of the present invention is obtained also by laminating the conductor layer of the stainless steel layer/conductor layer laminate on the one thermoplastic resin layer of the obtained resin board, and laminating the metal foil on the other thermoplastic resin layer of the obtained resin board, followed by bonding them by thermal compression.

### 3. Use of the Metal Laminate of the Present Invention

Although the metal laminate of the present invention can be used in arbitrary applications, it can be used as a circuit board when the metal layer is subjected to a circuit-patterning. Preferably it can be used as a suspension for a hard disk or a base material for a flexible wiring board.

A suspension for a hard disk is a part having spring properties and mounting a head section for magnetic reading function, but does not have to mount the head section and can be partially integrated with other parts. Further, it includes such parts as a flexure for a hard disk suspension that is to be used for other parts such as a load beam and the like. A method for manufacturing them is not particularly restricted, and they can be manufactured by a publicly known method, for example, by the method disclosed in Japanese Patent Publication No. H11-284294, and the like.

In addition, a circuit board obtained from the metal laminate of the present invention is also useful as a flexible wiring board, since it hardly produces noises even in high density circuit patterning and it has good adhesion among each layer.

### EXAMPLES

In the following, the present invention will be explained more specifically by referring to Examples, though it is not restricted by them at all.

Abbreviations used in the Examples for acid anhydrides, diamines and solvents are listed below.

<Acid Anhydrides> PMDA: pyromellitic dianhydride, BPDA: 3,3′,4,4′-biphenyltetracarboxylic dianhydride.
<Diamines> PPD: paraphenylenediamine, m-BP: 4,4′-bis(3-aminophenoxy)biphenyl, ODA: 4,4′-diaminodiphenyl ether.
<Solvents> DMAc: N,N′-dimethylacetamide, NMP:

### N-methylpyrrolidone.

### Syntheses Examples

### Syntheses of Non-Thermoplastic Polyimide Precursor

A solution was prepared by weighing 5.36 g of PPD as the diamine component, and 10.05 g of BPDA and 3.19 g of PMDA as the tetracarboxylic dianhydride components and dissolving them in 74.4 ml of NMP. The obtained solution was stirred and mixed for a reaction time of 6 hours at the reaction temperature of 23° C. The obtained reaction solution contained 20% by weight of solid components. The viscosity of the reaction solution was 30000 cps at 25° C., and it was suitable for coating. This was designated as polyamic acid varnish A.

A solution was prepared by weighing 4.73 g of m-BP and 6.00 g of ODA as the diamine components, and 9.20 g of PMDA as the tetracarboxylic dianhydride component and dissolving them in 79.7 ml of DMAC. The obtained solution was mixed for a reaction time of 6 hours at the reaction temperature of 23° C. The obtained reaction solution contained 20% by weight of solid components. The viscosity of the reaction solution was 20000 cps at 25° C., and it was suitable for coating. This was designated as polyamic acid varnish B.

Polyamic acid varnish A and polyamic acid varnish B were mixed at a weight ratio of 77 to 23 to obtain a precursor of non-thermoplastic polyimide, which was used in the Examples described later.

### Example 1

### Formation of a Conductor Layer on a Stainless Steel Foil

A masking film was laminated on one surface of a “SUS 304H” foil with thickness of 25 μm (manufactured by Nippon Steel Corp.) in order to prevent from a nickel strike treatment, while a nickel strike treatment was performed on the other surface to form a nickel underlying layer of about 0.10 μm thickness. The nickel strike treatment was performed in aqueous solution containing 100 g/l of nickel chloride and 125 g/l of hydrochloric acid under a current density of 4.0 A/dm² for 30 seconds.

Then, a copper layer was laminated on the nickel layer by an electroplating method. The electroplating was performed in aqueous solution containing 200 g/l of copper sulfate and 50 g/l of sulfuric acid under a current density of 5.0 A/dm² for 15 min at the solution temperature of 30° C. The thickness of the copper layer was approximately 3.0 μm as measured by a contact-type thickness measurement instrument (manufactured by Heidenhain K.K.).

### <Etching Treatment of a Conductor Layer Surface>

A stainless steel layer/conductor layer laminate was immersed for 15 seconds at 35° C. in aqueous solution of commercially available sulfuric acid/peroxide-type etching solution “Neo Brown NBDII” (produced by Ebara Densan, Ltd.) which was diluted with water to ½ concentration. It was judged by a visual check of the surface after the roughing treatment that there was no over-etching as the stainless steel underlying layer was not exposed and only the copper layer was etched. The surface of the copper layer after the immersion was observed and the surface roughness was analyzed by Nanopics (manufactured by Seiko Instruments Inc.). It was shown that the 10-point average surface roughness Rz was 1.5 μm.

### <Formation of a Polyimide Resin Layer on a Copper Foil>

Thermoplastic resin composition “Larc-TPI” (produced by Mitsui Chemicals, Inc.) was applied on a commercially available copper foil (trade name NK 120, manufactured by Nikko Materials Co., Ltd.) with a roll coater (manufactured by Inoue Metaworking industry Corp.) and dried at 130° C. (the thickness of the layer was 1.0 μm). The precursor of non-thermoplastic polyimide obtained by the above-mentioned synthesis example was applied and dried in the same manner (the thickness of the layer was 8.0 μm). Further, thermoplastic resin composition “PI-A” (produced by Mitsui Chemicals, Inc.) was applied and dried (the thickness of the layer was 2.0 μm). Then, they were heated up to 300° C. at the heating rate of 10° C./minute for imidation to obtain a polyimide metal laminate.

### <Bonding of a Stainless Steel Layer/Conductor Layer (Copper Layer) to a Polyimide Resin Layer/Metal Layer (a Copper Layer) by Thermal Compression>

The conductor layer of the stainless steel layer/conductor layer obtained as above was disposed on the polyimide resin layer of the polyimide resin layer/metal layer, and they were subjected to thermal compression by a pressing machine (manufactured by Kitagawa Seiki Co., Ltd.) under the conditions at 300° C. and 80 kgf/cm² for one hour.

### <Measurement Method of Peel Strength>

An etching mask treatment (3.2 mm width and 40 mm length) was performed on the stainless steel layer. Then, unnecessary parts of the stainless steel layer and the conductor layer underneath thereof were removed by an etching treatment with aqueous ferric chloride solution to obtain a measurement sample of the stainless steel layer with 3.2 mm width. The peel strength was measured by peeling the edge of a remained foil of a stainless steel layer (a metal foil was peeled in the direction of 90°) by using a peel measurement instrument (manufactured by Yasui Seiki Co., Ltd.). The results are shown in Table 1.

### Example 2

A polyimide metal laminate was prepared and evaluated in the similar manner to Example 1, except that the treatment with Neo Brown II on the surface of the copper layer formed as the conductor layer was performed for 20 seconds. It was judged that there was no over-etching since the stainless steel underlying layer was not exposed by the treatment with Neo Brown II. The 10-point average surface roughness Rz of the copper layer after the etching treatment was 1.8 μm. The results are shown in Table 1.

### Example 3

A polyimide metal laminate was prepared and evaluated in the similar manner to Example 1, except that the treatment with Neo Brown II on the surface of the copper layer formed as the conductor layer was performed for 30 seconds. It was judged that there was no over-etching since the stainless steel underlying layer was not exposed by the treatment with Neo Brown II. The 10-point average surface roughness Rz of the copper layer after the etching treatment was 2.6 μm. The results are shown in Table 1.

### Example 4

A polyimide metal laminate was prepared and evaluated in the similar manner to Example 1, except that the time for plating at the step of forming the conductor layer on the stainless steel foil was 10 minutes. It was judged that there was no over-etching since the stainless steel underlying layer was not exposed by the treatment with Neo Brown II. The 10-point average surface roughness Rz of the copper layer after the etching treatment was 1.4 μm. The results are shown in Table 1.

### Example 5

A polyimide metal laminate was prepared and evaluated in the similar manner to Example 1, except that the time for plating at the step of forming the conductor layer on the stainless steel foil was 80 minutes. It was judged that there was no over-etching since the stainless steel underlying layer was not exposed by the etching treatment. The 10-point average surface roughness Rz of the copper layer after the etching treatment was 1.5 μm. The results are shown in Table 1.

### Example 6

A polyimide metal laminate was prepared and evaluated in the similar manner to Example 1, except that, instead of the treatment by sulfuric acid/peroxide-type etching solution “Neo Brown NBDII”, the stainless steel layer/conductor layer laminate was immersed in a commercially available formic acid-based etching solution “CZ-8100” (produced by Mec Co., Ltd.) at 35° C. for 15 seconds, and further the stainless steel layer/conductor layer laminate immersed in “CL-8301” (produced by Mec Co., Ltd.) at room temperature for 30 seconds as the after-treatment. It was judged by a visual check of the surface after the roughing treatment that there was no over-etching as the stainless steel underlying layer was not exposed and only the copper layer was etched. The 10-point average surface roughness Rz of the copper layer after the treatment was 1.5 μm. The results are shown in Table 1.

### Comparative Example 1

A polyimide metal laminate was prepared and evaluated in the similar manner to Example 1, except that an etching treatment on the copper surface formed as the conductor layer was not performed. The 10-point average surface roughness Rz of the copper layer without the etching treatment was 0.3 μm. The results are shown in Table 1.

### Comparative Example 2

A polyimide metal laminate was prepared and evaluated in the similar manner to Example 1, except that an etching treatment on the copper surface formed as the conductor layer was performed for 40 seconds. The 10-point average surface roughness Rz of the copper layer after the etching treatment was 2.8 μm. The conductor layer was over-etched as the stainless steel foil was seen by a visual check of the conductor layer surface.

The results are shown in Table 1.

### Comparative Example 3

A polyimide metal laminate was prepared and evaluated in the similar manner to Example 1, except that, instead of the treatment with sulfuric acid/peroxide-type etching solution “Neo Brown NBDII”, the stainless steel layer/conductor layer laminate was immersed in aqueous solution containing 1% by weight of ammonium persulfate at 35° C. for 20 seconds. It was judged that there was no over-etching since the stainless steel underlying layer was not exposed by the etching treatment. The 10-point average surface roughness Rz of the conductor layer after the etching treatment was 0.3 μm. The results are shown in Table 1.

TABLE 1

| | | | | | | | Comparative | Comparative | Comparative |
|---|---|---|---|---|---|---|---|---|---|
| | Example 1 | Example 2 | Example 3 | Example 4 | Example 5 | Example 6 | Example 1 | Example 2 | Example 3 |
| Thickness of | 3 | 3 | 3 | 2 | 16 | 3 | 3 | 3 | 3 |
| conductor layer | | | | | | | | | |
| (μm) | | | | | | | | | |
| Plating time | 15 | 15 | 15 | 10 | 80 | 15 | 15 | 15 | 15 |
| (minutes) | | | | | | | | | |
| Over-etching | No | No | No | No | No | No | No | Yes | No |
| 10-Point | 1.5 | 1.8 | 2.6 | 1.4 | 1.5 | 1.5 | 0.3 | 2.8 | 0.3 |
| average | | | | | | | | | |
| roughness (μm) | | | | | | | | | |
| Adhesion | 160 | 170 | 140 | 160 | 150 | 290 | 20 | 160 | 90 |
| strength (g/mm) | | | | | | | | | |

As shown in Table 1, it can be seen that the metal laminate whose conductor layer was subjected to the etching treatment (Examples 1 to 6 and Comparative Examples 2 and 3) has higher adhesion strength than the laminate without the etching treatment (Comparative Example 1). This is due to excellent adhesion between the conductor layer and the polyimide resin layer.

It can also be seen that the metal laminate of Comparative Example 3 has lower adhesion strength than those in Examples 1 to 6. This indicates that the treatment with acidic etching solution is more effective than the treatment with aqueous solution of ammonium persulfate. Furthermore, it can be seen that the metal laminate of Comparative Example 3 is slightly improved in its adhesion strength even though the surface roughness (the 10-point average roughness) of the conductor layer is not changed from the conductor layer before the etching treatment. The reason for this is inferred that the brittle layer at the outermost surface of the conductor layer was removed.

In addition, although the metal laminate in Comparative Example 2 has the same level of adhesion strength as compared with Examples 1 to 5, it is inferred that reduction of noise, and the like may not be sufficiently achieved when used as a base material for a circuit board, since its conductor layer is over-etched and thus incapable of fully functioning as a ground.

### INDUSTRIAL APPLICABILITY

According to the present invention, a metal laminate composed of a stainless steel layer/a conductor layer/a polyimide resin layer/a metal layer, wherein the conductor layer and the polyimide resin layer adhere firmly can be manufactured, and it can be used as a hard disk suspension having excellent electrical properties.

This application claims priority from Japanese Patent Application No. 2005-119315, filed on Apr. 18, 2005. All the contents described in the specification of the application will be incorporated herein by reference.

1. A metal laminate comprising:
a stainless steel layer;
a conductor layer disposed on at least one surface of the stainless steel layer;
a polyimide resin layer disposed on a surface of the conductor layer; and
a metal layer disposed on a surface of the polyimide resin layer,
wherein a surface of the conductor layer in contact with the polyimide resin layer is not smooth.

2. The metal laminate according to claim 1, wherein a 10-point average surface roughness Rz of the conductor layer in contact with the polyimide resin layer is 0.5 μm or more and not more than the value obtained by subtracting 0.3 μm from the thickness of the conductor layer.

3. The metal laminate according to claim 1, wherein a surface of the conductor layer in contact with the polyimide resin layer is subjected to an acid treatment.

4. The metal laminate according to claim 3, wherein the acid treatment is performed by using a solution containing formic acid, or a solution containing sulfuric acid and a peroxide.

5. The metal laminate according to claim 1, wherein a thickness of the conductor layer is in a range of 0.5 μm to 20 μm.

6. The metal laminate according to claim 1, wherein the conductor layer is composed of copper or copper-based alloy.

7. The metal laminate according to claim 1, wherein the polyimide resin layer is composed of a non-thermoplastic polyimide layer and thermoplastic polyimide layers disposed on each of both surfaces of the non-thermoplastic polyimide layer.

8. A method for manufacturing a metal laminate composed of a stainless steel layer, a conductor layer disposed on at least one surface of the stainless steel layer, a polyimide resin layer disposed on a surface of the conductor layer, and a metal layer disposed on a surface of the polyimide resin layer, comprising a step of:
bonding the conductor layer of a stainless steel layer/conductor layer laminate composed of the stainless steel layer and the conductor layer to the polyimide resin layer of a polyimide metal laminate composed of the metal layer and the polyimide resin layer by a thermal compression,
wherein the stainless steel layer/conductor layer laminate is a laminate obtained by subjecting a surface of a conductor layer formed on a stainless steel foil by a plating method to an acid treatment.

9. A method for manufacturing a metal laminate composed of a stainless steel layer, a conductor layer disposed on at least one surface of the stainless steel layer, a polyimide resin layer disposed on a surface of the conductor layer, and a metal layer disposed on a surface of the polyimide resin layer, comprising steps of:
forming the polyimide resin layer on the conductor layer of a stainless steel layer/conductor layer laminate composed of the stainless steel layer and the conductor layer; and
bonding a metal foil on the formed polyimide resin layer by thermal compression,
wherein the stainless steel layer/conductor layer laminate is a laminate obtained by subjecting a surface of the conductor layer formed on a stainless steel foil by a plating method to an acid treatment.

10. A suspension for a hard disk that contains a processed article of the metal laminate according to claim 1.
